(19) United States
(12) Patent Application Publication
(10) Pub. No.: US 2018/0239138 A1
(43) Pub. Date: Aug. 23, 2018

(54) COMPUTER DATA INPUT-OUTPUT DEVICE

(71) Applicants: Olga DEMCHENKO, Kyiv (UA); Dmytro DEMCHENKO, Kyiv (UA)

(72) Inventors: Olga DEMCHENKO, Kyiv (UA); Dmytro DEMCHENKO, Kyiv (UA)

(21) Appl. No.: 15/898,429

(22) Filed: Feb. 17, 2018

(30) Foreign Application Priority Data
Feb. 17, 2017 (UA) A201701512
Feb. 17, 2017 (UA) U201701513

(51) Int. Cl. G02B 27/01; G06F 3/0481; G06F 3/01

(52) U.S. Cl. CPC G02B 27/017; G06F 3/04815; G02B 2027/0178; G02B 2027/014; G06F 3/011

(57) ABSTRACT

Computer data input and output device includes indication unit in the form of display—eyeglass, coordinate sensors, as well as program module that controls data input and output. The display screen is installed on the place of eye-glass lens. The device is equipped with minicomputer with a program module designated for wireless communication with coordinate sensors, with computer and with an indication unit. The device includes hardware and software suite that is composed of mentioned coordinate sensors, indication unit and minicomputer with a program module installed on minicomputer. The suite realizes data exchange function with computer to convert coordinate sensors position in space in cursor position on indication unit display screen and realizes interaction of minicomputer with indication unit and with coordinate sensors. The device is equipped with extra program module designated to be installed on computer to realize virtual keyboard function and “mouse”.

### CROSS-REFERENCE TO RELATED APPLICATIONS

The present patent application claims priority to Ukranian patent application No. a201701512 filed Feb. 17, 2017 and Utility model application No. u201701513 filed Feb. 17, 2017, currently allowed.

### FIELD OF INVENTION

The present patent application refers to constructions of electronic computing machines, mainly to personal computers, and may be used both in everyday life and in various national economy branches.

### BACKGROUND

Nowadays, electronic devices became affordable for general consuming public, as a result of this a probability of crimes connected with them got increased as well. In particular, the crimes based on thievery of private information such as correspondence either private and/or business, thievery of personal audio and video images for the purpose of their further reselling, blackmailing etc. Rather essential part of varieties of thievery is represented by a banal watching of what is going on the screen of computer's monitor and/or smartphone in public place, thus a password can be stolen for any Internet resource, the consequences whereof can be less predictable and absolutely disagreeable for a legal owner. Same process, as a rule, happens during data input and output as the keyboard can either be asounded as it goes with smartphones by input signal tone, or may be also stolen. Moreover, the passwording process may be videorecorded by a trespasser and after a while determined for lucrative purposes. Except direct theft of information, it worth taking into consideration a natural wish of a user to keep in confidence his correspondence, review of video content and other information that has personal value.

We know about biotechnical adapted device for keyboardless data input (SU authorship certificate No 1576901, IPC 5 G 09 B 21/00, G 06 F 3/00, published on Apr. 07, 1990), which may be used for keyboardless presentation and registration of information in the form of generalized finger movements (coordinate Xt) and wrist (coordinate Yt); coordinate signals are output by means of bioactivity sensors installed on proximal maniphalanges and hand backs, thus simplifying a device due to length decrease of operative coordinate motored symbol alphabet in the form of separate movements; for this purpose a generalized M-reflex symbol classification device is installed in decoder of coordinate motored symbol movements containing the channels of bioactivity lead-off from sensors with amplifiers and integrators, which outputs are connected with inputs of amplitude converter linked with inputs of convolution node, at that second inputs of convolution node are connected with pulse generator outputs, and its third input is connected with first output of device, which second and third inputs are connected with first and second outputs of amplitude converter, forth input is connected with signal bus “Initial installation”, at that second and third outputs of device are connected with information and strobing outputs of coordinate motored symbols decoder, third output is connected also through OR element with fifth input of decoder and sixth input of convolution node, which second output is connected with second input of amplitude converter and second input of decoder, first and second outputs of amplitude converter are connected with information and address inputs of convolution node.

We also know about biotechnical adapted device for keyboardless data input (see. SU, authorship certificate No 1836676, IPC G 06 F 3/02, G 09 B 21/00, published on Aug. 23, 1993) by force of coordinate motored finger and wrist movements without vision attraction that contains the elements of influence of fingers and wrist activity sensors, scanning unit performed on the base of pulse generator, AND-N elements, separators, readout registers, counters, NOT elements, keys and amplifiers, coding unit performed on OR element block, elements that switch off OR from first to third one and decoders, first and second decoders of coordinate motored activity, each of them is performed on multiplexor, first, second and third wrist activity sensors, first and second single vibrator and amplifiers; finger and wrist activity sensor contains elements of influence of finger flexors, support, stand, elements of influence of finger extensors, cover, flexible hollow rod from dielectric, guide, bracelet body, quasisensors with amplifiers, metalized cup, flat spring.

Above stated devices are very complicated and requires high operator's skills, his preliminary training on simulator. Under external work-impeding conditions, for instance, affect of external noise, outsider conversations, vibrations, temperature fall, using of such devices becomes problematic. The shortcomings of above stated devices are that it is difficult to realize them in the form of compact electronic circuit, as well as there is a necessity for individual microcircuit programing in the framework of rigid certain logic.

It is also known the closest by technical essence to the proposed one, a device for computer data input and output (patent RU No 22101752, IPC G 06 F 3/02, published on Oct. 01, 1998) that contains indication unit in the form of display—eyeglass, at that the display screen is installed on the place of eye-glass lens, coordinate sensors, as well as program module that controls computer data input and output, at that this device contains physical computer—connected keyboard, indication unit connected to computer output, coordinate sensors are installed on keyboard surface, through interface of coordinate sensors they are additionally connected to computer input and designated to register operator's hand position over the keyboard; computer and keyboard may be constructively located in single unit, the keyboard may be performed in the form of adjustable panels, computer and keyboard may be constructively located in single unit, the keyboard may be performed with possibility to change its dimensions or in the form of several panels interconnected by hinge joint and installed with possibility to be rotated relatively the hinge joint axle and combination of wide panel surfaces between themselves.

The shortcoming of the described device is a necessity to use physical keyboard without which the device operation is impossible, and moreover it is impossible to guarantee by 100% the privacy of data input and output as anyone can spy what is entered during keyboarding operation as well as availability of wire communication at that will notably decrease ergonomic parameters and reliability during operation; it is impossible to realize this device in the form of compact electrical circuit and as a result—diminutiveness of its performance that provides mobility while its usage.

### SUMMARY

A computer data input and output device of the present invention includes a display screen, coordinate sensors, and a computer with wireless communication between them. The computer converts a coordinate sensors position in space in a cursor position on the indication unit display screen. The coordinate sensors are fastened to phalanges and communicatively connected with other components of the device to create a virtual keyboard. Additionally, the coordinate sensors perform the function of a “mouse”.

### BRIEF DESCRIPTION OF THE DRAWING

FIG. 1 illustrates principle of operation of the method and device of the present invention.

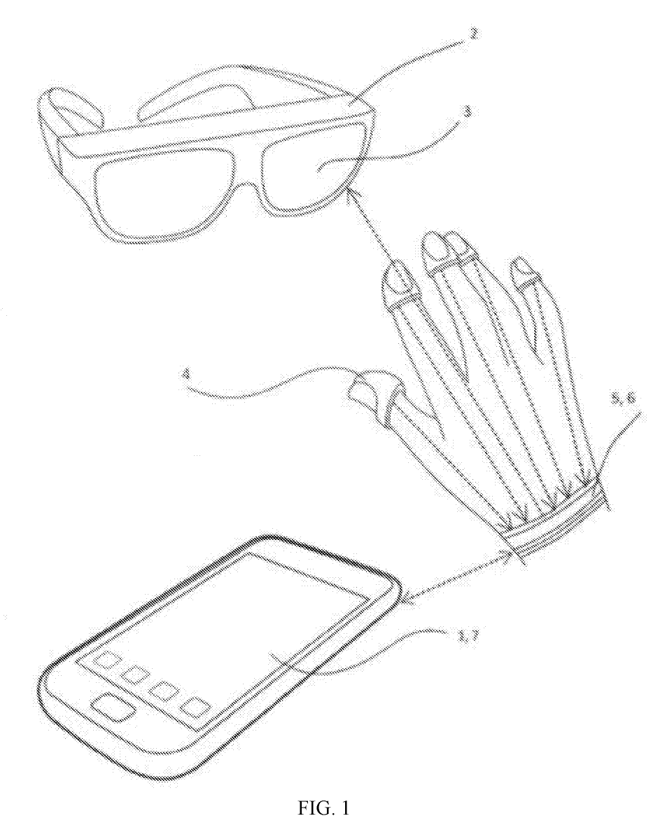

### DETAILED DESCRIPTION OF THE PREFERRED EMBODIMENT

By the term computer in this application is meant any device that contains a processor, RAM and the ability to process information. This concept includes, but is not limited to: industrial computers, personal computers, laptops, netbooks, tablets, smartphones, bracelets (apple watch and other manufacturers), virtual reality glasses and other devices.

The current invention aims to increase privacy level while data input and output due to exclusion of physical keyboard as well as due to growth of device operation reliability and improvement of ergonomic parameters due to exclusion of wire communication, simplification, and realization of device in the form of compact electrical circuit and as a result—diminutiveness of its performance that provides mobility while its usage.

To solve this task, a device for computer data input and output that contains indication unit in the form of display—eyeglass, at that the display screen is installed on the place of eye-glass lens, coordinate sensors, as well as program module that controls data input and output, according to utility model is equipped by minicomputer with program module designated for wireless communication with coordinate sensors, with computer and indication unit, as well as hardware and software suite that is composed of mentioned coordinate sensors, indication unit and minicomputer with a program module installed on minicomputer that realizes data exchange function with computer to convert coordinate sensors position in space in cursor position on indication unit display screen and realizes interaction of minicomputer with indication unit and with coordinate sensors as well as it is equipped with extra program module designated to be installed on computer to realize virtual keyboard function and “mouse”, at that coordinate sensors are performed with possibility to be fastened to phalanges and by traffic connected with minicomputer, in addition at various performance options the proposed device may be provided with extra software designated for text, graphic, sound and other editors, communication application (messengers), browsers, games and software solutions and shells used in modern household and professional computer equipment; mentioned minicomputer can be equipped with computer in single unit or installed self-contained; set of accelerometers can be used as coordinate sensors able to measure coordinates of their location in space: coordinate sensors are equipped with gyroscope; coordinate sensors are equipped with magnetometer; coordinate sensors are equipped with accelerometer; coordinate sensors are performed either closed or opened; coordinate sensors are equipped with confirmation sensor; coordinate sensors are equipped with radio module.

This device which dimensions are determined by size of eye-glasses, microcomputer and computer enables operator to use it not only as a stationary working place but also as mobile one that is achieved for the first time. As sensors are fastened to fingers, there is a possibility to transmit data to computer by pressing any surface without use of physical keyboard; there is no chance to peep data input. At that, number of sensors can be variated from one to infinity depending on number of user's working extremities and its ability to use them by such designation. Location of each cursor on the screen is determined by position of each finger in space. Device provides fully-featured substitute for the keyboard and/or “mouse” being their combination and enables to transmit data to computer by protected channels depriving of opportunity of potential thief to steal input information. As a monitor, the virtual reality eye-glasses are used in which a user can see the content of the monitor/smartphone screen thus enabling him to keep privacy at work. As a result, a user, while being in public places, can use modern wireless communication means provided to him by up-to-date computer equipment thus helping to simplify the device and increase its reliability.

The picture below shows a general view of computer data input and output device.

Computer data input and output device (1) contains indication unit (2) in the form of display—eyeglass, at that the screen (3) of indication unit (2) in the form of display installed on the place of eye-glass lens, coordinate sensors (4), as well as program module (5) that controls data input and output, according to invention the device is equipped with minicomputer (6) with program module (5) designated for wireless communication with coordinate sensors (4), with computer (1) and indication unit (2), as well as hardware and software suite that is composed of mentioned coordinate sensors (4), indication unit (2) and minicomputer (6) with a program module (5) installed on minicomputer (6) that realize data exchange function with computer (1) to convert coordinate sensors (4) position in space in cursor position on screen (3) of indication unit display (2) and realize interaction of minicomputer (6) with indication unit (2) and coordinate sensors (4) as well as it is equipped with extra program module (7) designated to be installed on computer (1) to realize virtual keyboard function and “mouse, at that coordinate sensors (4) are performed with possibility to be fastened to phalanges and by traffic connected with minicomputer (6), in addition at various performance options a proposed device may be provided with extra software designated for text, graphic, sound and other editors, communication application (messengers), browsers, games and software solutions and shells used in modern household and professional computer equipment; mentioned minicomputer (6) can be combined with computer (1) in single unit or installed self-contained; set of accelerometers can be used as coordinate sensors (4) able to measure coordinates of their location in space: coordinate sensors are equipped with gyroscope and/or magnetometer and/or accelerometer; as well as they are performed either closed or opened; coordinate sensors (4) are equipped with confirmation sensor and/or coordinate sensors (4) are equipped with radio module.

Proposed computer data input and output device operates as follows. Extra program module (7) is installed on computer (1). Operator's finger position is registered by coordinate sensors (4) and by means of interface of coordinate sensors (4), information on fingers position is converted in digital data processed by minicomputer (6) and come on input of computer (1). Afterwards these data are processed in computer (1) and microcomputer (6) according to their operation programs and from output of computer (1) via minicomputer (6) are displayed on screen (3) of indication unit (2) in the form of display installed on the place of eye-glass lens in the shape of visual information. Software installed on microcomputer (6) and computer (1) converts position of coordinate sensors (4) in space in position of cursors on screen (3). Thus operator monitors over screen (3) simultaneously input and output data and manipulates by pressing the keys of virtual keyboard. A key selected by cursor on virtual keyboard is registered by confirmation sensor (not shown) that can be done, for example, by pressing the key either of which is located on appropriate coordinate sensor (4). Coordinate sensors (4) change their reading when operator moves his fingers in space. Components are equipment with radio modules for wireless communication.

What is claimed is:

1. A computer data input and output device, comprising an indication unit in a form of a display—eyeglass, a display screen being installed on the place as eyeglass lens, coordinate sensors, a computer, as well as a first program module that controls a computer data input and a computer data output, which differs in that it is equipped with a minicomputer with a second program module designated for wireless communication with the coordinate sensors, with the computer and the indication unit, as well as a hardware and software suite that is composed of the mentioned coordinate sensors, the indication unit and the minicomputer with the second program module installed on the minicomputer that realizes data exchange function with the computer to convert a coordinate sensors position in space in a cursor position on the indication unit display screen and realizes interaction of the minicomputer with the indication unit and with the coordinate sensors as well as it is equipped with an extra program module designated to be installed on the computer to realize a virtual keyboard function, wherein the coordinate sensors are performed to be fastened to phalanges and communicatively connected with the minicomputer.

2. The device of claim 1, which differs in that it is equipped with an extra software designated for text, graphic, sound and other editors, communication application (messengers), browsers, games and software solutions and shells used in modern household and professional computer equipment.

3. The device of claim 1, which differs in that the mentioned minicomputer is combined with the computer into a single unit or installed as self-contained.

4. The device of claim 1, which differs in that a set of accelerometers is used as coordinate sensors being able to measure coordinates of their location in space.

5. The device of claim 1, which differs in that the coordinate sensors are equipped with a gyroscope.

6. The device of claim 1, which differs in that the coordinate sensors are equipped with a magnetometer.

7. The device of claim 1, which differs in that the coordinate sensors are equipped with an accelerometer.

8. The device of claim 1, which differs in that the coordinate sensors are performed as closed and opened.

9. The device of claim 1, which differs in that the coordinate sensors are equipped with a confirmation sensor.

10. The device of claim 1, which differs in that the coordinate sensors are equipped with a radio module.

11. The device of claim 1, wherein the computer is a smart phone.

12. The device of claim 1, wherein the computer is a laptop.

13. The device of claim 1, wherein the computer is a smart watch.

14. The device of claim 1, wherein the computer includes virtual reality glasses.

15. The device of claim 1, wherein the coordinate sensors perform a function of a “mouse”.
